(19) United States
(12) Patent Application Publication
(10) Pub. No.: US 2025/0229226 A1
(43) Pub. Date: Jul. 17, 2025

(54) MODULARIZED GAS BIO-TRICKLING FILTER DEVICE AND METHOD FOR EFFICIENT VOC (VOLATILE ORGANIC COMPOUND) AND ODOUR TREATMENT

(71) Applicant: Council of Scientific & Industrial Research, New Delhi (IN)

(72) Inventor: Partha Kundu, Thiruvananthapuram (IN)

(21) Appl. No.: 19/020,579

(22) Filed: Jan. 14, 2025

(30) Foreign Application Priority Data
Jan. 15, 2024 (IN) 202411002844

(51) Int. Cl. B01D 53/85; B01D 53/34; B01D 53/96

(52) U.S. Cl. CPC B01D 53/85; B01D 53/346; B01D 53/96; B01D 2251/95; B01D 2253/102; B01D 2257/708; B01D 2257/90; B01D 2258/06

(57) ABSTRACT

Gas bio-trickling filter (g-BTF) processes are provided for polluted air purification mainly focusing on the treatment of VOCs and odor using low-cost filter media (agricultural waste i.e., wood char coal and other waste i.e., sludge, compost etc.) that is cheap and readily available. Apparatus for purifying volatile organic compounds and odor control enriched air stream uses a consortium of the microorganisms including Rhodococus sp., Paracocus sp, Microbacterium sp., Mutant Paracocus denitrificans sp. The consortium approach ensures a broader range of VOC degradation capabilities, allowing for efficient removal of multiple compounds simultaneously. This versatility makes biotrickling filters highly adaptable to different industrial settings, such as paint manufacturing plants or automotive facilities. Compared to other process (thermal and chemical process), the developed BTF process are associated with the lowest operating and maintenance costs. Overall VOC and odor removal efficiency of the g-BTF unit is 99.9%.

### CROSS-REFERENCES TO RELATED APPLICATIONS

This application claims benefit of priority under 35 U.S.C. § 119 to Indian Patent Application number 202411002844, filed Jan. 15, 2024, incorporated by reference herein in its entirety.

### TECHNICAL FIELD

This application is directed generally to air purification apparatus and, more specifically, to apparatus for purifying an air stream containing volatile organic compounds and/or odors.

### BACKGROUND

Large amounts of organic solvents are used in automotive painting booths. On average, more than 6 kg of volatile organic compounds (VOCs) are used as paint solvents per vehicle in typical automotive plants with solvent based coatings. The metals and plastics used for automobiles have been painted for both decoration and protection against corrosion. The paints used contain organic polymers and solvents. These compounds can be photo-chemically reactive and can negatively affect local air quality. The solvents contribute to air pollution, as volatile organic compounds (VOCs), when emitted during painting operations.

Commonly used solvents in solvent-based paints include: aromatic hydrocarbons, aliphatic hydrocarbons, esters, ketones, alcohols, and glycolethers. VOCs have been the focus of environmental concern and regulated for two basic reasons: human health issues due to some VOCs being toxic and ozone formation through photochemical reactions with NOx. Other than solvent-based paints, water-based paints and powdered paints have been used. However, water-based paints are not organic solvent free and still contain a significant amount of organic solvents along with the water. Organic solvents are also hydrophilic in nature, e.g., alcohols, ketones, and glycolethers, etc., compared to those in solvent-based paints that contain a significant portion of hydrocarbons, such as toluene and xylenes. Similarly, pungent/foul odor emission from automobile spray painting units and flour mills during spice grinding causes serious environmental problem.

Automobile spray painting units and allied industry (i.e., flour mills etc.) causes VOC and odor emission in several parts of the state. Generally, there is no emission factor data available on odor and VOC emissions from such MSMs. The control of VOC and odor emissions will become an increasingly important issue. The lack of emission factor data will hamper the selection and design of all types of air pollution control systems, leading to installation of ineffective and inappropriate devices.

Control of VOC emissions, such as by selective catalytic and non-catalytic reduction, usually requires high temperatures and the use of chemicals and catalysts, therefore resulting in high costs and generation of secondary pollutants; in this framework, biological methods represent a promising alternative.

VOCs are a group of organic compounds that are difficult to handle, as are aliphatic and aromatic organic compounds and the emissions of VOCs are now an evolving ecological concern. Industrial processes, automotive emissions, and solvent use are among the key sources of VOC emissions. Many chemical compounds are formed from human activities and are distinct by their solubility in water, concentration or availability differentials, and reactivity levels. VOCs contained inside the gases can react with each other, subject to chemical changes, modify one another's properties, and affect bioavailability and hence the rate of biodegradation. The major VOCs present in the atmosphere produced mainly from the painting, chemical, and petrochemical industries are benzene, toluene, ethylbenzene, and xylene.

In recent years, people are more aware of the possible health and ecological risks that are caused by industrially produced chemical pollutants and it eventually leads to the development of stricter rules and regulations in VOC production. The discharge of harmful chemical contaminants, especially VOCs, has been a major problem worldwide. Paint sprays exhaust gas includes VOCs such as benzene, toluene, ethylbenzene, and xylene (BTEX) and also other complex compounds such as chlorinated benzene and toluene, all of which can cause greater harm to humans. The indiscriminate emission of huge quantities of exhaust gas from paint spray often harms the ambient atmosphere. Therefore, effective technologies for the treatment of paint spray exhaust gas and its effects are needed.

### SUMMARY

Embodiments herein provide an apparatus (100) for purifying Volatile Organic Compounds and odor control enriched air stream which includes a multistage adsorption column (9) comprising of a sprout shaped bottom section for air inlet (9B), uniform distribution section (28), compartmentalize porous adsorption section (9C1, 9C2), and top air outlet vent (9T) with aqueous medium circulation loop (24).

Some embodiments include an apparatus (100) wherein the sprout bottom section (9B) connected with an air blower (2), air flow meter (8), control valve (4) with associated line connection (6).

Some embodiments include an apparatus (100) wherein there is an aqueous recirculation loop (42) for each compartment of the column.

Some embodiments include an apparatus (100) wherein the recirculation loop is equipped with a pump (26) and valves (20, 22).

Some embodiments include an apparatus (100) which consists of specially developed packing media embedded with microorganism (MPM) selected from the group comprising of Rhodococus sp., Paracocus sp., Microbacterium sp., Mutant Paracocus Denitrificans sp.

Some embodiments include an apparatus (100) wherein a volatile organic compound active carbon-based adsorption device (9), comprises of: vertically mounted column compartments (9B, 9C1, 9C2, 9T), column internal interlude (28, 29, 31, 32, 35, 36, 38, 39) fixed mounting has the mixed packed media, MPM (mixed with specific cultured microorganism) layered wise, MPM adsorption layer top of the compartment is equipped with the aqueous steam distributor (34, 40).

Some embodiments include an apparatus (100) wherein the MPM compartment (9C1) and adsorption compartment (9C2) is connected with manifolds (i.e., flange and gasket) and comprises of agricultural biomass waste derived highly porous carbon packing material.

Some embodiments include an apparatus (100) wherein, it utilizes low cost, highly efficient and eco-friendly packing media (i.e., agricultural waste based) for VOC and odor treatment.

Some embodiments are directed to a process of treatment of Volatile Organic Compounds and odor enriched polluted air stream comprising the steps of: absorption, biodegradation/biotransformation, diffusion and adsorption.

An objective of embodiments herein includes providing an environmentally friendly inexpensive and highly effective process for control of VOC and odor.

It is another objective to provide a device for deodorization of air utilizing biofilter system where pressure loss during passage of air is low.

It is yet another objective to provide a device for deodorization of air, which is able to retain and provide large moisture content for support of growth of micro-organisms.

It is yet another objective develop a new application for an agricultural and solid waste which, at present, incurs disposal costs.

All the above objectives are achieved by the developing of a modular g-BTF using eco-friendly packing media. Still another object is to provide a BTF process for deodorization of air which is able to sustain activity for a long duration without compaction, ageing and pressure build-up. This object is achieved by passing contaminated air through a specially designed compartmentalized packing bed which providing support for microbial growth.

### BRIEF DESCRIPTION OF THE DRAWINGS

FIG. 1 is g-BTF process flow diagram for VOC and odor emission control, where 1 represent AC power supply; 2 represent blower; 3 represent VFD; 4, 5, 7, 20, 21, 22, 23, 25 represent control valve; 6 represent solvent (VOC) vessel; 8 represent gas flow meter; 9 represent g-BTF reactor; 10, 18 represent VOC analysis port; 11, 12 represent pressure tap; 13 represent moisture sensor; 14 represent temperature sensor; 15 represent gas analysis port; 16 represent online CO₂ analyser; 17 represent manometer; 19 represent gas sampling port; 24 represent circulating nutrient vessel; 26 represent circulating pump, in accordance with embodiments herein.

FIG. 2 is a schematic 3D cross-sectional view illustrating g-BTF column reactor according to embodiments herein.

FIG. 3 is a cross-sectional view illustrating the bottom section (B) of g-BTF reactor, where 27 represent restrain clamp; 28 represent orifice distributor; 29 represent shell bed; 30 represent gasket according to embodiments herein.

FIG. 4 is a cross-sectional view illustrating the first compartment section (C1) of g-BTF reactor, where 31 represent restrain clamp with orifice distributor; 32 represent mesh; 33 represent MPM packing media; 34 represent liquid nozzle distributor according to embodiments herein.

FIG. 5 is a cross-sectional view illustrating the second compartment section (C2) of g-BTF, where 35 represent restrain clamp; 36 represent mesh; 37 represent carbon based packing media; 38 represent orifice distributor; 39 represent restrain clamp with mesh according to embodiments herein.

FIG. 6 is a cross-sectional view illustrating the top section (T) of g-BTF reactor, where 40 represent liquid nozzle distributor; 41 represent treat air (clean air) plenum according to embodiments herein.

FIG. 7 is representing pressure drop profile of g-BTF reactor according to embodiments herein.

FIG. 8 is representing the mechanism of treatment of VOC enriched gas stream in g-BTF reactor according to embodiments herein.

FIG. 9 is representing Removal efficiency of VOC mixture in g-BTF reactor according to embodiments herein.

FIG. 10 is representing Phylogenetic tree of Paracoccus sp & Rhodococcus sp strains immobilized in MPM packing media used in g-BTF reactor according to embodiments herein.

### DETAILED DESCRIPTION

Numerous technologies for the removal of VOCs have recently been established in response to increasing concern about the issue. As conventional pathways for the treatment of VOCs, physical, chemical, and biological strategies have been used. As state-of-the-art technique, thermal combustion processes are conventionally used in fields of industrial application which is energy intensive.

In contrast, biofilters are energy. While thermal combustion processes are characterized by both high construction costs (USD 14.52-29.04 per cubic meter of treated gas) and operating costs (USD 1.70-8.70 per 1000 cubic meters) and bioprocesses are low-cost processes with costs of USD 2.84-17.01 per cubic meter and USD 0.14-0.87 per 1000 cubic meters, respectively. Biological techniques such as bio-trickling filter (BTF) can be used, due to their cost-effectiveness and environmental-friendliness. Considering the trend of the emissions resulting from the incineration, the developed bio-trickling filter (BTF) have been regarded as an efficient, cost-effective, alternative biological cleaner production process for the treatment and control of air pollution. Based on the field visit and sampling, a lab-scale Biofilter trickling filter (BTF) process has been developed for VOC and odor emission control. The biological treatment utilizes microbes to treat contaminant emitted in the air. Physicochemical and biological phenomena occur simultaneously during the pollutants degradation in the biofilm of a biotrickling filtration system. Biotransformation occurs along with adsorption, absorption and diffusion to remove contaminants from the gaseous stream. In the presence of microorganism mainly bacteria in biofilm will aerobically degrade the targeted pollutant(s).

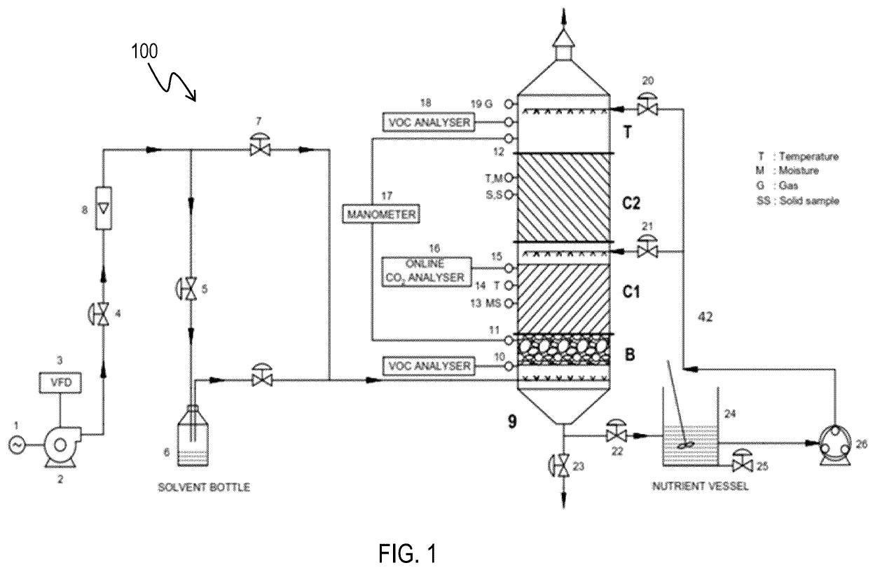

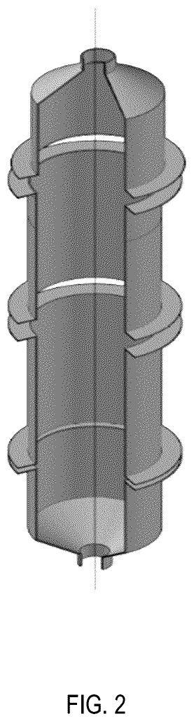

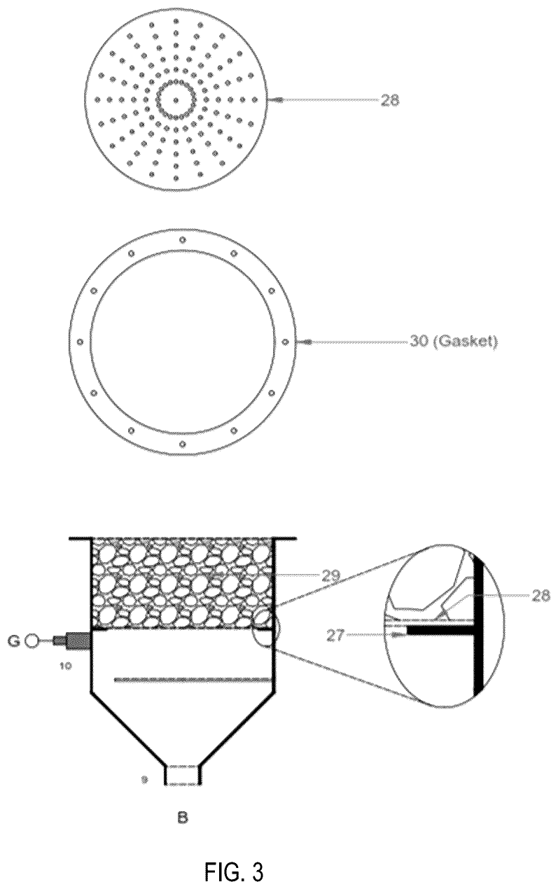

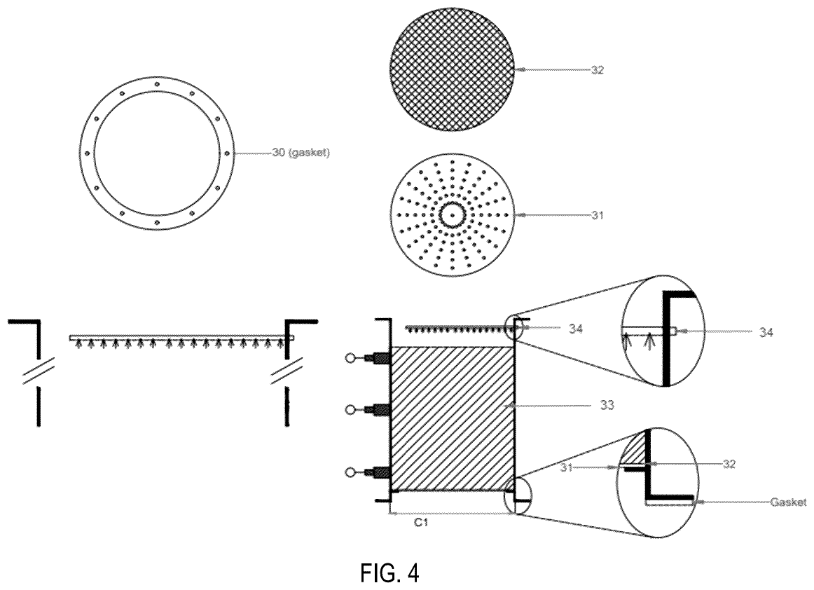

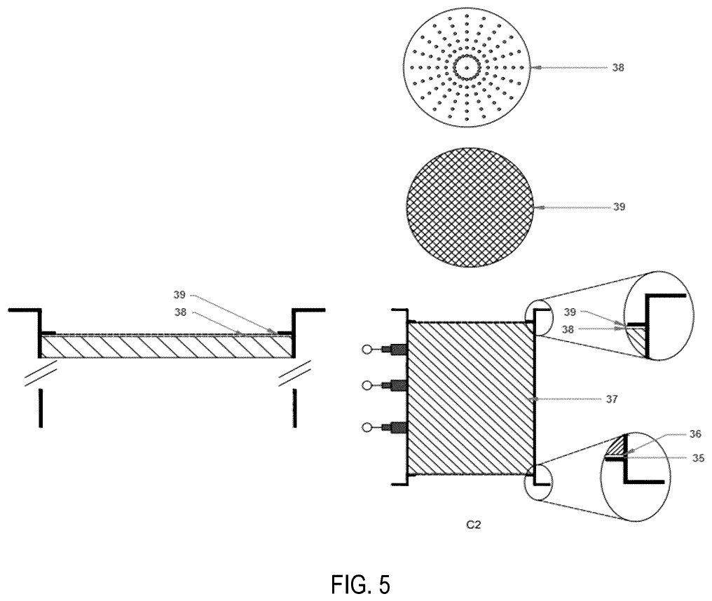

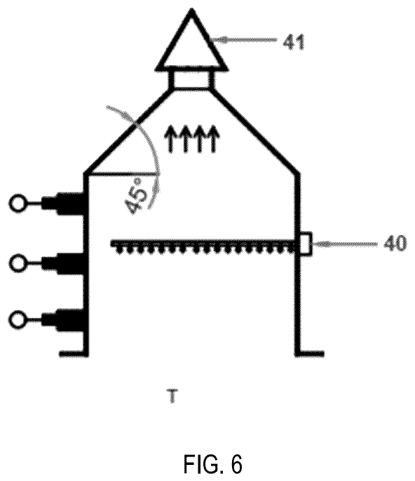

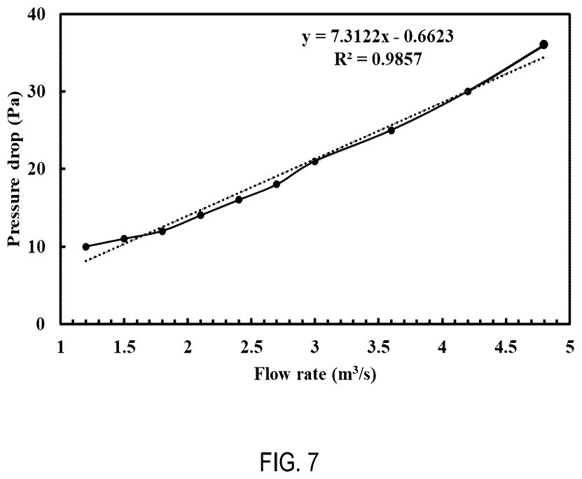

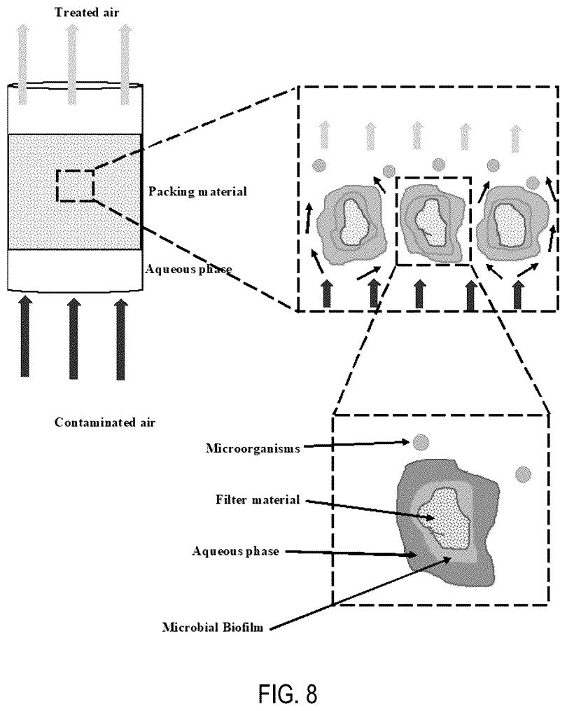

The system is equipped with the continuous recirculation of the aqueous phase containing the essential inorganic nutrients. The trickling liquid is circulated back to the top of the filter by a centrifugal pump and is homogenously distributed on the top surface of the bed by head spray system. The liquid (nutrient) medium trickled on the filter bed from the top of the bed at a certain fixed rate and polluted gaseous stream is entering from the bottom of the reactor. Based on the field emission data a pilot scale gas Bio-trickling filter (BTF) was developed which is showed in FIGS. 1-6. Pressure drop profile of BTF reactor is showed in FIG. 7. Conceptual VOC degradation mechanism occurred in BTF unit is represented in FIG. 8. Physicochemical and biological phenomena occur simultaneously during the VOC degradation in the biofilm of a biotrickling filtration system. Biotransformation occurs along with absorption, adsorption, and diffusion to remove contaminants from the gaseous stream. In the presence of microorganism mainly bacteria in biofilm will aerobically degrade the targeted pollutant(s). Details of BTF reactor is shown in Table 1. Detail characteristics of the mixed packed media (MPM) are mentioned in Table 2.

Pilot scale bio-trickling filter setup is equipped with, VFD controller (for controlling air flow rate), Digital manometer (for analyzing pressure drops), Mass flow meter (for regulating inlet flow rate), Rotameter (for regulating volumetric gas flow rate), moisture analyzer (for monitoring moisture content of the biofilter bed), blower, Solvent bottle (for injecting VOC to BTF), VOC meter (for quantifying inlet and outlet pollutant concentration), pump (for feeding nutrients), Bio-trickling filter column, Nutrient vessel (for providing nutrients to the microbes and moisture to the filter bed).

The mixed packing material (MPM) was composed of wood charcoal, mature compost and seed sludge as inoculum. Wood charcoal is a readily available, low cost, and affordable. It is locally available, relatively cheap and easier to handle. Wood charcoal was prepared by control combustion of agricultural waste material (i.e., wood) at 400° C. to 500° C. under limited oxygen environment. Seed sludge was collected from a sewage treatment plant in Muttathara, Trivandrum, Kerala (8° 27′32.62″N and 76° 56′15.08″E). A specific ratio of compost, wood charcoal and sludge was mixed and used for packing media for the biofiltration process. Here wood charcoal acts as the adsorbent as well as supporting media for microbial attachment whereas, sludge will act as the inoculum for biodegradation and finally, mature compost will provide the macro as well as micro nutrients for the microbial growth.

TABLE 1
Design specification of Bio-trickling filter

| Parameter | Value | |
|---|---|---|
| Total height of the BTF reactor | 1.524 | m |
| Effective height of the bed | 0.9144 | m |
| Thickness of the column | 0.002 | m |
| Diameter of the column | 0.3048 | m |
| Cross sectional area of the column | 0.0729 | m² |
| Surface area of the column | 2.333 | m² |
| Volume of the bed | 0.666 | m³ |
| Empty Bed Residence Time (EBRT) | 120 | s |

TABLE 2
Characteristics of mixed packed media (MPM)

| Characteristics | Value | |
|---|---|---|
| Moisture content | 21.84% | |
| pH | 6.7 | |
| Total organic carbon | 31.87% | |
| Volatile solids | 64.36% | |
| Total dissolved solids | 35.32 | ppm |
| Conductivity | 70.66 | μS/cm |
| Salinity | 0.03 | psu |
| Resistivity | 14.1K | ohm · cm |
| Bulk density | 0.71 | g/c³ |
| Particle density | 1.32 | g/c³ |

| | |
|---|---|
| Porosity | 46.21% |
| Water retention capacity | 88% |

The developed gas bio-trickling filter (BTF) unit is packed with specially prepared agricultural waste based highly porous packing media inoculated with aerobic microbial consortia to treat VOC enriched gas i.e., acetone, 2-butanone, ethyl acetate, methanol, toluene, xylene and six component VOC mixture representative of solvents present in off gases emitted by industrial spray-painting operations. Performance evaluation of g-BTF unit is presented in Table 3. The major findings are mentioned below.

The suitability, robustness and effectiveness for BTF in VOC abatement have been demonstrated. BTF can be successfully employed to biodegrade VOCs from waste gas streams representative of paint spray booth off-gases. The high performance BTF unit exhibited excellent VOC removal efficiency (RE>99%).

When the influent gas stream passes through BTF unit which exhibited stable long-term performance with an average total VOC removal greater than 99% even when operated with an EBRT of 120 s and an average loading rate of 116.52 g m⁻³ h⁻¹.

BTF unit also showed high elimination capacity for all sets of VOC component. Elimination capacity of BTF unit is followed the trends as mentioned below.

BTF Elimination Capacity: 2-butanone>toluene>VOC mixture>acetone>xylene>methanol>ethyl acetate>Benzene.

Growth of diverse micro-organism in the packing media helped to develop a stable and efficient microbial population capable of achieving high VOC removal rates in BTF.

The developed BTF unit showed good job stabilization which can swiftly conveniently installed at place. Moreover, the reactor dismantling of reactor and change of VOC adsorbent are very convenient to use.

TABLE 3
Performance evaluation of g-BTF unit

| Sample. | | VOC Removal | Odor removal |
|---|---|---|---|
| No. | VOC components | efficiency (%) | efficiency (%) |
| 1. | Toluene | 99.99 | 99.00 |
| 2. | Benzene | 98.70 | 95.80 |
| 3. | Xylene | 99.99 | 99.99 |
| 4. | 2-butanone | 99.99 | 99.99 |
| 5. | Acetone | 99.99 | 99.99 |
| 6. | Methanol | 99.99 | 99.99 |
| 7. | Ethyl acetate | 99.99 | 99.99 |
| 8. | VOC mixture | 99.99 | 99.99 |

### EXAMPLES

The examples provided in this section are to be considered as illustrative and should not be construed to limit the scope of this disclosure or the appended claims.

The BTF process followed multi-step procedure in which biologically active packed media played an important role for treatment of VOCs and odor. The process of VOC biodegradation in BTF is complexed, which is grouped by spatial scale into the biofilm level, the medium level, and the reactor level. A detailed mechanism is showed in FIG. 8.

VOC enriched air stream is passed through the mixed packed media which is immobilized with microorganism. Inlet gas stream is passed through the BTF reactor vertically upwards and comes in contact of the outer liquid film of the microbial biofilm in MPM, where absorption of VOCs from (i.e., mass transfer) gas phase to the liquid phase is taking place. The circulating nutrients steam (i.e., liquid phase) helps the growth of microorganism in MPM. The gas diffuses through the gas-liquid contact interface into the microbial biofilm of MPM. Diffused VOC components (i.e., pollutants) are adsorbed on the surface of the MPM, where microorganisms biodegraded (i.e., biologically oxidize) the VOC component and bio-transformed into carbon dioxide, water, and biomass. Microorganism immobilised in MPM completely destroy the VOC contaminants and desorbed lean air stream released from the top of the BTF reactor.

MPM was characterized by XRD analysis. The XRD pattern of MPM exhibited very sharp and narrow peaks at 2θ=26°, which indicates that the packing material is crystalline in nature. ATR spectra of MPM revealed that, the band visible at 1218 cm⁻¹ corresponds to the stretching vibration of the C—O for the carbon monoxide or carbon dioxide derivatives. Table 4 represents the various peaks obtained in the ATR spectra and corresponding functional groups present in the MPM.

TABLE 4
Peaks and corresponding functional groups
present in the ATR spectra of MPM

| Peaks (cm⁻¹) | Functional group |
|---|---|
| 1581 | C═C |
| 1432 | C—H |
| 1218 | C—O |
| 872 | Aromatic C—H |
| 815 | Aromatic C—H |

The BTF unit has flexible and changeable process, and can adjust and flexibly combine the parameters of each group of process sections according to the incoming material condition of the volatile organic compound so as to adapt to wider working conditions and ensure the effective treatment of the volatile organic compound.

Removal efficiency (RE) of BTF unit for different type of VOCs was studied (Table 3). RE of each individual VOC tested was used to evaluate the treatment performance of BTF. RE was calculated using eq. (1).

$$RE ( \% ) = \frac{{C}_{in} - {C}_{out}}{{C}_{in}} \times 100 \qquad ( 1 )$$

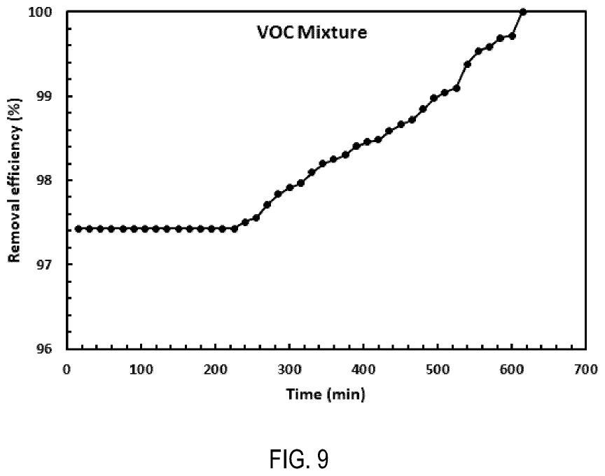

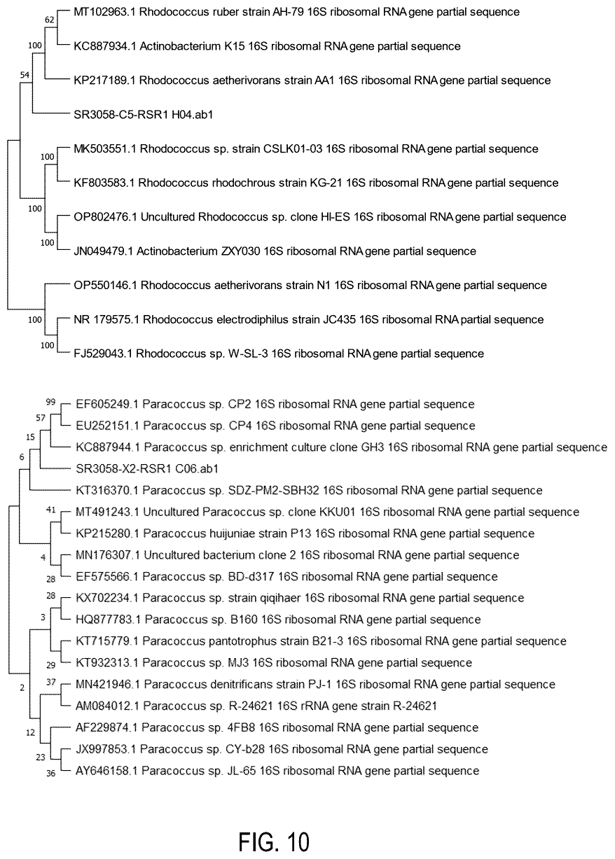

VOC mixture consists of toluene, benzene, xylene, 2-butanone, ethyl acetate, methanol and acetone in different ratios. VOC loading rate in the BTF was maintained as 116.55 g·m³/h. As shown in FIG. 9, it was found that the removal efficiency of VOC mixture remains constant i.e., 97.4% over a period of 250 minutes. After 250 minutes the removal rate increased gradually, and finally reached the maximum that is 100% within a time of 600 minutes. Bacteriological assay analysis of microbial consortia used in the BTF unit was analyzed using 16S rRNA sequencing and Phylogenetic tree of Paracoccus sp and Rhodococcus sp strains are shown in FIG. 10.

There are several advantages of the apparatus and methods of this disclosure. Traditional methods used to control VOC emissions, such as selective catalytic and non-catalytic reduction, usually require high temperatures and the use of chemicals and catalysts, therefore resulting in high costs and generation of secondary pollutants; in this framework, biological methods represent a promising alternative. A comparison of details is mentioned in Table 5.

TABLE 5
Comparison of various process for VOC & odor control

| Sample | VOC and odor | Suitable for inlet | Equipment | Operating |
|---|---|---|---|---|
| No. | control Method | concentration | cost | cost |
| 1. | Absorption | % Level | Low | Low |
| 2. | Adsorption | ppm | Medium | Medium |
| 3. | Incineration | ppm | High | High |
| 4. | catalytic | ppm | High | High |
| 5. | g-Bio-trickling filter | ppm | Low | Low |

The choice of filtration media in biofiltration systems also played a crucial role in the performance and efficacy of the process. Plastic media, while commonly used, may have limitations due to their low surface area and porosity, which can hinder microbial growth and attachment. Activated carbon layers, although effective in adsorbing pollutants, may impede microbial accessibility to the target compounds.

Polyether and polyester media offer favorable conditions for microbial colonization due to their high surface area and porosity. However, the hydrophobic nature of these materials may affect moisture retention, impacting microbial activity. Bio-ceramic media, with their porous structure, show potential for microbial attachment and growth, but careful selection is required to ensure compatibility with microorganisms. The developed biotrickling filtration (BTF) process for VOC and odor control is eco-friendly and cost effective as the filter media required (i.e., prepared from agricultural waste) is cheap and readily available.

Prepared agricultural waste-based media possess a porous structure, which offers a high surface area for microbial attachment and growth. The porosity facilitates the diffusion of volatile organic compounds (VOCs) through the media, enhancing their contact with the microbial consortium. This increased surface area and porosity can lead to improved VOC removal efficiency in biotrickling filters. These materials often contain residual organic matter, minerals, and other nutrients that can support microbial growth and metabolic activity. The availability of nutrients helps sustain the activity of VOC-degrading microorganisms, promoting efficient VOC removal.

As compared to other processes (thermal and chemical process) the BTF process herein is associated with the lowest operating and maintenance costs. Process does not require periodic replacement of packing elements and periodic regeneration of liquid which make the proposed BTF technology environment-friendly and commercially viable.

What is claimed is:

1. An apparatus for purifying an air stream from volatile organic compounds or odors, the apparatus comprising:
a multistage adsorption column having vertically mounted column compartments, the multistage adsorption column comprising:
a sprout shaped bottom section comprising an air inlet having an orifice distributor;
a mixed packed media compartment;
a porous adsorption section; and
a top air outlet vent having a circulating nutrient vessel.

2. The apparatus of claim 1, further comprising an air blower, an air flow meter, and a control valve, each of the air blower, an air flow meter, and a control valve being connected to the sprout bottom section by an associated line connection.

3. The apparatus of claim 1, wherein the sprout shaped bottom section comprises a bed of biological material as an acid neutralizing agent.

4. The apparatus of claim 1, wherein the bed of biological material comprises a shell bed of calcium carbonate.

5. The apparatus of claim 1, wherein each of the vertically mounted column compartment comprises an aqueous recirculation loop.

6. The apparatus of claim 5, wherein the aqueous recirculation loop is equipped with a pump and valves.

7. The apparatus of claim 5, wherein the aqueous recirculation loop is adapted to periodically trickle a nutrient solution through a bed of Na₂HPO₄, K₂HPO₄, KH₂PO₄, (NH₄)₂PO₄, MgSO₄, CaSO₄, FeSO₄·H₂O, or C₆H₁₂O₆.

8. The apparatus of claim 1, wherein the mixed packed media compartment comprises a mixed packed media embedded with a microorganism selected from the group consisting of Rhodococus sp., Paracocus sp., Microbacterium sp., and Mutant Paracocus denitrificans sp.

9. The apparatus of claim 1, wherein:
the vertically mounted column compartments comprise column internal interlude fixed mountings comprising a mixed packed media mixed with a cultured microorganism; and
respective top portions of the vertically mounted column compartments are equipped with an aqueous steam distributor.

10. The apparatus of claim 1, wherein:
the mixed packed media compartment and the adsorption compartment are connected with a flange and a gasket; and
the mixed packed media compartment further comprises a highly porous carbon packing material derived from agricultural biomass waste.

11. The apparatus of claim 1, further comprising eco-friendly packing media for volatile organic compounds and odor treatment.

12. A process for removing volatile organic compounds and odors from a polluted air stream, the method comprising using the apparatus according to claim 1 on the polluted air stream for processes of absorption, diffusion, adsorption, and biodegradation/biotransformation.
